(19) United States
(12) Patent Application Publication
(10) Pub. No.: US 2012/0155471 A1
(43) Pub. Date: Jun. 21, 2012

(54) METHOD AND APPARATUS FOR ROUTING

(75) Inventors: Byung Bog Lee, Daejeon (KR); Jae Hong Ryu, Daejeon (KR); Myung Nam Bae, Daejeon (KR); Byeong Cheol Choi, Daejeon (KR); In Hwan Lee, Daejeon (KR)

(73) Assignee: ELECTRONICS AND TELECOMMUNICATIONS RESEARCH INSTITUTE, Daejeon (KR)

(21) Appl. No.: 13/316,956

(22) Filed: Dec. 12, 2011

(30) Foreign Application Priority Data
Dec. 15, 2010 (KR) 10-2010-0128565
Mar. 16, 2011 (KR) 10-2011-0023473

(51) Int. Cl. H04L 12/56; H04L 12/28

(52) U.S. Cl. 370/392

(57) ABSTRACT

A router relays sensing data between a field network including at least one sensor node and a plant network including a management system. The routing apparatus manages a routing table in which a next address and an output interface corresponding to an extension destination address of 6 bytes and an input interface are stored and transmits sensing data to another field network or a management system using the routing table.

### CROSS-REFERENCE TO RELATED APPLICATION

This application claims priority to and the benefit of Korean Patent Application No. 10-2010-0128565 and 10-2011-0023473 filed in the Korean Intellectual Property Office on Dec. 15, 2010 and Mar. 16, 2011, the entire contents of which are incorporated herein by reference.

### BACKGROUND OF THE INVENTION

(a) Field of the Invention

The present invention relates to a method and apparatus for routing. More particularly, the present invention relates to routing between field networks having different address systems.

(b) Description of the Related Art

A field network generally includes IEEE 802.15.4 and international society of automation (ISA) 100.11 a using a short address system of 2 bytes and Bluetooth using an extension address system of 6 bytes in a medium access control (MAC) hierarchy.

However, because address systems of a field network are different, routing between field networks may be difficult. Therefore, technology of operating a simplified routing table is necessary.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for routing having advantages of simplifying and operating a routing table.

An exemplary embodiment of the present invention provides a method of routing a router in a relay network between a field network including at least one sensor node and a plant network including a management system. The method includes receiving first sensing data from the sensor node of the field network; searching for, when a destination of the sensing data is a sensor node of another field network, a routing table in which path information corresponding to an extension destination address is stored using an input interface and a destination address of the first sensing data; and transmitting the sensing data with reference to a next address and an output interface of a record corresponding to the input interface and the destination address of the first sensing data.

Another embodiment of the present invention provides a method of routing a router in a relay network between a field network including at least one sensor node and a plant network including a management system. The method includes receiving sensing data in which a destination is displayed as null from the sensor node of the field network; searching for a routing table in which path information corresponding to an extension destination address is stored using an input interface and a destination address of the sensing data; and transmitting the sensing data to the management system with reference to a next address and an output interface of a record corresponding to the null and an input interface of the sensing data.

Yet another embodiment of the present invention provides a router of a relay network that relays data between a field network including at least one sensor node and a plant network including a management system. The router includes a routing table and a routing controller. The routing table stores a next address and an output interface corresponding to an extension destination address and an input interface. When a destination address of sensing data that receive from a sensor node of the field network is a short MAC address, the routing controller converts the short MAC address to an extension MAC address and that transmits the sensing data through a next address and an output interface of a record corresponding to the extension MAC address and an input interface of sensing data with reference to the routing table.

### BRIEF DESCRIPTION OF THE DRAWINGS

FIG. 1 is a diagram illustrating a smart plant management network according to an exemplary embodiment of the present invention.

FIG. 2 is a diagram illustrating an address system of a smart plant management network according to an exemplary embodiment of the present invention.

FIG. 3 is a diagram illustrating a router according to an exemplary embodiment of the present invention.

FIG. 4 is a diagram illustrating an example of an address conversion method.

FIG. 5 is a flowchart illustrating a routing method between field networks according to an exemplary embodiment of the present invention.

FIG. 6 is a flowchart illustrating a routing method between a field network and a plant network according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the specification and claims, unless explicitly described to the contrary, the word “comprise” and variations such as “comprises” or “comprising”, will be understood to imply the inclusion of stated elements but not the exclusion of any other elements.

Hereinafter, a method and apparatus for routing according to an exemplary embodiment of the present invention will be described in detail with reference to the drawings.

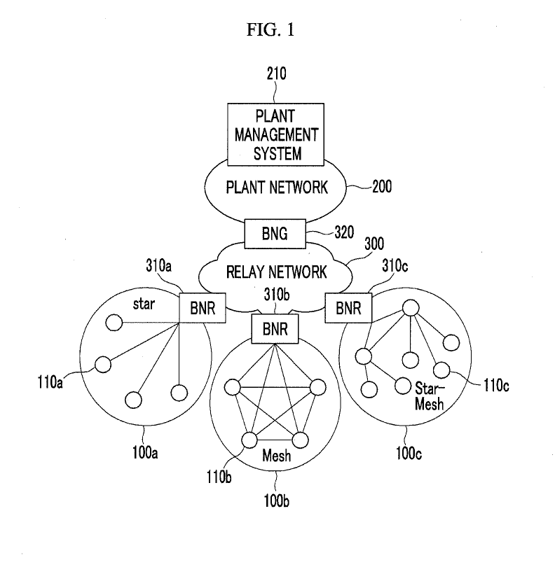

FIG. 1 is a diagram illustrating a smart plant management network according to an exemplary embodiment of the present invention.

Referring to FIG. 1, the smart plant management network includes at least one field network, for example, field networks 100a, 100b, and 100c, a plant network 200, and a relay network 300.

A smart plant is formed by applying sensor network technology and can be used for maintenance of various kinds of power plants such as thermal power, complex thermal power, and atomic power as well as a chemical engineering plant of a crude oil and gas processing equipment, a petrochemical and crude oil refined facility, and a gas plant of liquefied natural gas (LNG).

The field networks 100a, 100b, and 100c include a plurality of sensor nodes 110a, 110b, and 110c, respectively.

The sensor nodes 110a, 110b, and 110c are attached to a plant equipment to sense and transmit data of diagnosis information on a state of the sensor nodes 110a, 110b, and 110c, a state of a process, and a state of other equipments that are connected to a processor, such as a valve and a compressor.

In general, in order to have a communication protocol stack of a light weight to save battery power of the sensor nodes 110a, 110b, and 110c, the field networks 100a, 100b, and 100c are formed based on a non-Internet protocol (non-IP).

The field networks 100a, 100b, and 100c are mainly formed in a form of star topology, mesh topology, and star-mesh topology. FIG. 1 illustrates the field networks 100a, 100b, and 100c that are formed in a form of star topology, mesh topology, and star-mesh topology.

The field networks 100a, 100b, and 100c may use IEEE 802.15.4 and ISA 100.11a using a short medium access control (MAC) address system of 2 bytes and Bluetooth using a 6 byte address system.

The plant network 200 includes a plant management system 210 that performs a function of collecting, storing, and managing sensing data by the sensor nodes 110a, 110b, and 110c.

The relay network 300 includes backhaul network routers (hereinafter, referred to as a “BNR”) 310a, 310b, and 310c and a backhaul network gateway (hereinafter, referred to as a “BNG”) 320.

The BNRs 310a, 310b, and 310c provide routing between the field networks 100a, 100b, and 100c. That is, the BNRs 310a, 310b, and 310c receive sensing data from the sensor nodes 110a, 110b, and 110c of corresponding field networks 100a, 100b, and 100c, and when a destination of the sensing data is another field network, the BNRs 310a, 310b, and 310c perform a function of transmitting the sensing data to the another field network. Further, the BNRs 310a, 310b, and 310c perform a function of transmitting control data of the plant network 200 that receives through the BNG 320 to the sensor nodes 110a, 110b, and 110c of corresponding field networks 100a, 100b, and 100c.

The BNG 320 performs a function of supporting a flexible connection and extension of the field networks 100a, 100b, and 100c and the plant network 200.

The plant network 200 and the relay network 300 are an IP-based network, and Ethernet may be used as the plant network 200, and as the relay network 300, a wireless local area network (WLAN), a wide band code division multiple access (WCDMA) network, a wide band wireless network, a wireless network of Wi-Fi, and a high-speed downlink packet access (HSDPA) network may be used.

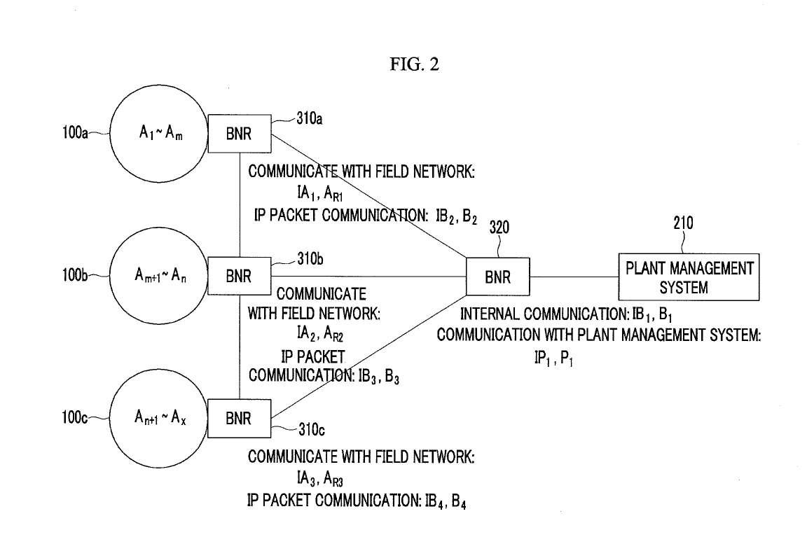

FIG. 2 is a diagram illustrating an address system of a smart plant management network according to an exemplary embodiment of the present invention.

In FIG. 2, the field network 100a includes m pieces of sensor nodes, the field network 100b includes n-m pieces of sensor nodes, and the field network 100c includes x-n pieces of sensor nodes.

Referring to FIG. 2, each sensor node of the field networks 100a, 100b, and 100c has an MAC address identifier that can be uniquely identified. For example, in the field network 100a, m pieces of sensor nodes have MAC addresses A₁-Aₘ, respectively, and in the field network 100b, n-m pieces of sensor nodes have MAC addresses Aₘ₊₁-Aₙ, respectively. In the field network 100c, x-n pieces of sensor nodes have MAC addresses Aₙ₊₁-A_{X}, respectively. The MAC addresses may be a short address of 2 bytes (16 bits) and an extension address of 6 bytes (48 bits) according to a type of a field network. For example, when the field networks 100a, 100b, and 100c are IEEE 802.15.4 and international society of automation (ISA) 100.11a, a short address of 2 bytes may be used as an address of each sensor node, and when the field networks 100a, 100b, and 100c are Bluetooth, an extension address of 6 bytes may be used as an address of each sensor node.

The BNRs 310a, 310b, and 310c according to an exemplary embodiment of the present invention have inner access point interfaces and MAC addresses for an interface of corresponding field networks 100a, 100b, and 100c, respectively. Further, the BNR 310a, 310b, and 310c each have network interfaces and IP addresses for IP packet communication. For example, the BNR 310a may have IA₁ and A_{R1} as an inner access point interface and an MAC address, respectively, for an interface of the field network 100a and may have IB₂ and B₂ as a network interface and an IP address for IP packet communication. The BNR 310b may have IA₂ and A_{R2} as an inner access point interface and an MAC address, respectively, for an interface of the field network 100b and may have IB₃ and B₃ as a network interface and an IP address, respectively, for IP packet communication. The BNR 310c may have IA₃ and A_{R3} as an inner access point interface and an MAC address, respectively, for an interface of the field network 100c and may have IB₄ and B₄ as a network interface and an IP address, respectively, for IP packet communication.

The BNG 320 of the relay network 300 has a network interface and an IP address for internal communication of the relay network 300, i.e., communication with the BNRs 310a, 310b, and 310c and communication with the plant management system 210 of the plant network 200. For example, the BNG 320 may have IB₁ and B₁ as a network interface and an IP address, respectively, for internal communication of the relay network 300 and have IP₁ and P₁ as a network interface and an IP address, respectively, for communication with the plant management system 210.

Sensing data and control data of the field networks 100a, 100b, and 100c are converted and transmitted to a user datagram protocol (UDP) packet based on each port number in the relay network 300 and the plant network 200. That is, the relay network 300 and the plant network 200 perform UDP packet communication. Therefore, the relay network 300 converts sensing data to an UDP packet of a predetermined port number of the plant network 200 and transmits the UDP packet to the plant management system 210, and the plant management system 210 converts control data for controlling the field networks 100a, 100b, and 100c to an UDP packet of a predetermined port number and transmits the UDP packet to the field networks 100 as, 100b, and 100c through the relay network 300.

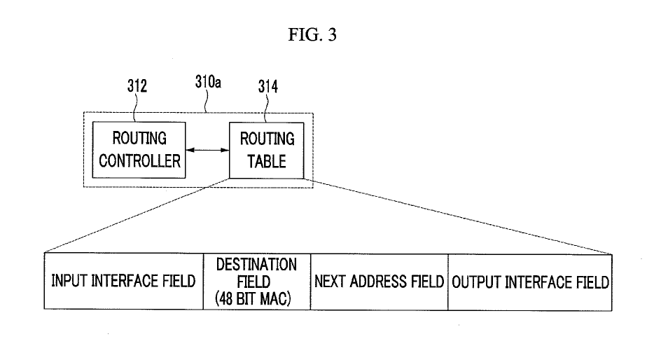

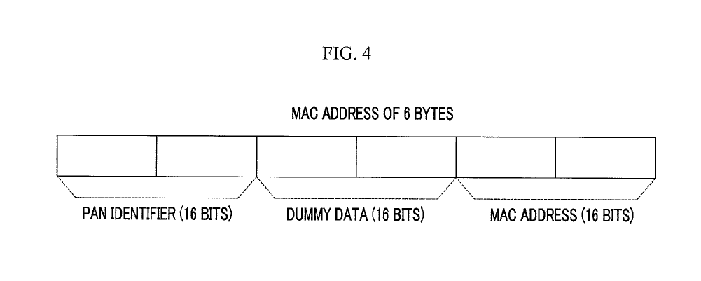

FIG. 3 is a diagram illustrating a router according to an exemplary embodiment of the present invention, and FIG. 4 is a diagram illustrating an example of an address conversion method.

Referring to FIG. 3, the BNR 310a includes a routing controller 312 and a routing table 314. FIG. 3 illustrates only the BNR 310a, but the BNRs 310b and 310c may be formed equally to the BNR 310a. That is, the BNRs 310a, 310b, and 310c have each routing table.

The routing table 314 stores path information to a specific destination. The routing table 314 includes an input interface field, a destination identifier field, a next address field, and an output interface field.

The input interface field is a field representing information of an interface to which sensing data or an UDP packet is input, and the input interface field stores information of an interface to which sensing data or an UDP packet is input.

The destination identifier field is a field representing destination information of sensing data or an UDP packet, and the destination identifier field stores destination information of the sensing data or the UDP packet. In this case, the destination information is stored as an MAC address of 6 bytes (48 bits). That is, an MAC address of 2 bytes (16 bits) is converted to an MAC address of 6 bytes by a conversion method of FIG. 4 and is stored as destination information in the destination identifier field.

The next address field is a field representing address information of a next address to pass through in order to transmit an UDP packet to the destination, and the next address field stores address information of a next address to pass through in order to transmit an UDP packet to the destination.

The output interface field is a field representing interface information for transmitting sensing data or an UDP packet, and the output interface field stores interface information for transmitting the sensing data or the UDP packet.

The routing controller 312 manages a routing table 314 and performs a function of routing the received data.

The routing controller 312 searches for a record corresponding to an input interface and a destination address of the received data in the routing table 314, and when a record corresponding to an input interface and a destination address of the received data exists in the routing table 314, the routing controller 312 routes data through a next address and an output interface of a corresponding record.

Because an MAC address of 6 bytes is stored in the destination address field of the routing table 314, when a destination address of the received data is an MAC address of 2 bytes, the routing controller 312 converts the MAC address of 2 bytes to the MAC address of 6 bytes and searches for the routing table 314 using the converted MAC address of 6 bytes as a key.

Referring to FIG. 4, the routing controller 312 determines a destination address of sensing data, and when the destination address is an MAC address of 2 bytes (16 bits), the routing controller 312 converts the MAC address of 2 bytes to an MAC address of 6 bytes using a personal access network (PAN) identifier of a field network having an MAC address of 2 bytes, dummy data of 2 bytes, and an MAC address of 2 bytes (16 bits). For example, a PAN identifier may be used for upper-level 16 bits, an MAC address may be used for lower-level 16 bits, and dummy data may be used for the remaining 16 bits.

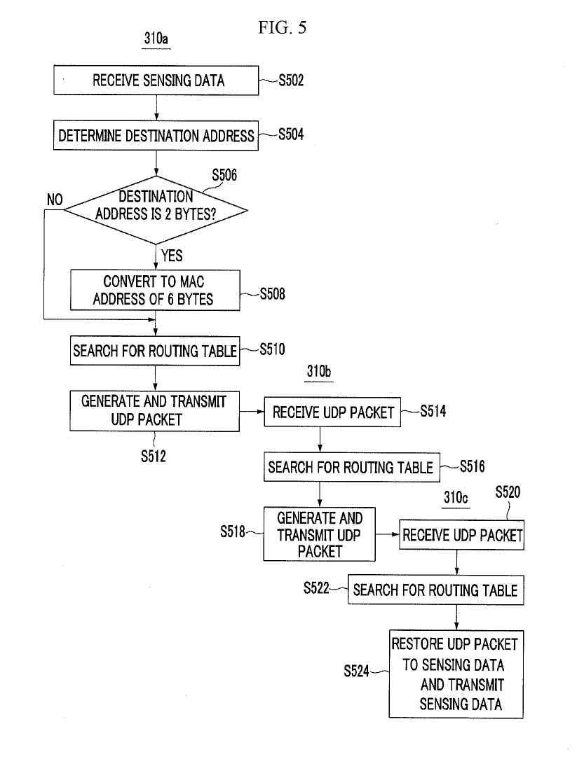

FIG. 5 is a flowchart illustrating a routing method between field networks according to an exemplary embodiment of the present invention.

FIG. 5 illustrates a routing method of transmitting sensing data that receive from the access point interface IA₁ of the field network 100a that is connected to the BNR 310a to an MAC address A_{X} of a sensor node of the field network 100c that is connected to BNR 310c.

First, when an MAC address of each sensor node of the field networks 100a, 100b, and 100c, an access point interface and an MAC address, and a network interface and an IP address of the BNRs 310a, 310b, and 310c, and a network interface and an IP address of the BNG 320 are the same as those of FIG. 2, it is assumed that a routing table of the BNRs 310a, 310b, and 310c is set, as shown in Tables 1 to 3.

TABLE 1

| Input interface | Destination | Next address | Output interface |
|---|---|---|---|
| field | identifier field | field | field |
| IA₁ | EAₘ₊₁-EAₙ | B₃ | IB₂ |
| IA₁ | EAₙ₊₁-EAₓ | B₃ | IB₂ |
| IA₁ | default | B₁ | IB₂ |
| IB₂ | EA₁-EAₘ | — | IA₁ |

TABLE 2

| Input interface | Destination | Next address | Output interface |
|---|---|---|---|
| field | identifier field | field | field |
| IAₘ₊₁ | EA₁-EAₘ | B₂ | IB₃ |
| IAₘ₊₁ | EAₙ₊₁-EAₓ | B₄ | IB₃ |
| IAₘ₊₁ | default | B₁ | IB₃ |
| IB₃ | EAₘ₊₁-EAₙ | — | IA₂ |
| IB₃ | EAₙ₊₁-EAₓ | B₄ | IB₃ |

TABLE 3

| Input interface | Destination | Next address | Output interface |
|---|---|---|---|
| field | identifier field | field | field |
| IAₙ₊₁ | EA₁-EAₘ | B₃ | IB₄ |
| IAₙ₊₁ | EAₘ₊₁-EAₙ | B₃ | IB₄ |
| IAₙ₊₁ | default | B₁ | IB₄ |
| IB₄ | EAₙ₊₁-EAₓ | — | IA₃ |

Referring to FIG. 5, when the BNR 310a receives sensing data through the access point interface IA₁ of the field network 100a (S502), the BNR 310a determines a destination address of the sensing data (S504).

The BNR 310a determines whether the destination address is an MAC address A_{X} of 2 bytes (S506), and if the destination address is an MAC address A_{X} of 2 bytes, the BNR 310a converts the destination address to an MAC address EA_{X} of 6 bytes (S508).

Next, the BNR 310a searches for a record corresponding to the access point interface IA₁ and the converted MAC address EA_{X} of 6 bytes at the routing table of Table 1 (S510). If the destination address is no MAC address of 2 bytes at step S506, the BNR 310a determines the destination address as an MAC address of 6 bytes and searches for the routing table of Table 1.

When the record corresponding to the access point interface IA₁ and the converted MAC address EA_{X} of 6 bytes exists in a routing table, the BNR 310a generates an UDP packet of a predetermined port number and transmits the UDP packet with reference to a next address B₃ and an output interface IB₂ of a corresponding record (S512). The BNR 310a writes an MAC address EA_{X} of 6 bytes in a front header portion of a payload of the UDP packet. In this case, an initial value of the MAC address is set as “0” in the front header portion of the payload, and when the MAC address is not “0” in the front header portion of the payload, the MAC address may be analyzed as an MAC address of 6 bytes.

Thereafter, the BNR 310b having a next address B₃ receives the UDP packet through the network interface IB₃ (S514).

The BNR 310b searches for a record corresponding to the network interface IB₃ and the MAC address EA_{X} of 6 bytes in the routing table of Table 2, as in the BNR 310a (S516).

When the record corresponding to the network interface IB₃ and the MAC address EA_{X} of 6 bytes exists in the routing table, the BNR 310b generates an UDP packet of a predetermined port number and transmits the UDP packet with reference to a next address B₄ and an output interface IB₃ of a corresponding record (S518).

Thereafter, the BNR 310c having the next address B₄ receives the UDP packet through a network interface IB₄ (S520).

The BNR 310c searches for a record corresponding to the network interface IB₄ and an MAC address EA_{X} of 6 bytes in the routing table of Table 3 (S522).

When a record corresponding to the network interface IB₄ and the MAC address EA_{X} of 6 bytes exists in the routing table, the BNR 310c determine that the received UDP packet is data of the field network 100c with reference to a next address (−) and an output interface IA₃ of a corresponding record, restores the UDP packet to sensing data, converts again an MAC address EA_{X} of 6 bytes to an MAC address A_{X} of 2 bytes, and transmits the sensing data to the MAC address A_{X} of 2 bytes (S524).

Therefore, a sensor node having an MAC address A_{X} receives corresponding sensing data.

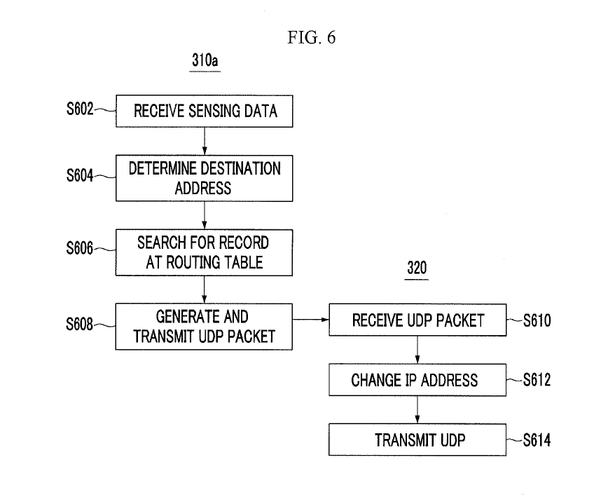

FIG. 6 is a flowchart illustrating a routing method between a field network and a plant network according to an exemplary embodiment of the present invention.

FIG. 6 illustrates a routing method of transmitting sensing data that receive from the access point interface IA₁ of the field network 100a that is connected to the BNR 310a to the plant management system 210 of the plant network, and it is assumed that a routing table of the BNRs 310a, 310b, and 310c is set, as shown in Tables 1 to 3.

Referring to FIG. 6, when a final destination of sensing data is the plant management system 210, a sensor node of the field network 100a sets a final destination as null data and transfers the sensing data to the BNR 310a.

When the BNR 310a receives sensing data through the access point interface IA₁ of the field network 100a (S602), the BNR 310a determines a destination address of the sensing data (S604).

The BNR 310a searches for a record corresponding to null data, which are a destination address and the access point interface IA₁ at the routing table of Table 1 (S606).

When the record corresponding to null data, which are a destination address and the access point interface IA₁ exists at the routing table of Table 1, the BNR 310a generates an UDP packet of a predetermined port number and transmits the UDP packet with reference to a next address B₁ and an output interface IB₁ of a corresponding record (S608).

Thereafter, the BNG 320 having an IP address of B₁ receives the UDP packet (S610).

The BNG 320 changes and sets a transmitting address of the UDP packet from B₁ to P₁ and transmits the UDP packet to the plant management system 210 (S612-S614).

Accordingly, the plant management system 210 receives the UDP packet.

According to an exemplary embodiment of the present invention, even when address systems of a field network are different, routing between field networks can be performed.

Further, by shortening a transmitting path of sensing data between field networks, a packet traffic load of a relay network can be reduced, and a newly added field network can be extended through the relay network, and thus flexibility of a network extension can be provided.

An exemplary embodiment of the present invention may be not only embodied through the above-described apparatus and/or method but also embodied through a program that executes a function corresponding to a configuration of the exemplary embodiment of the present invention or through a recording medium on which the program is recorded and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of routing a router in a relay network between a field network comprising at least one sensor node and a plant network comprising a management system, the method comprising:
receiving first sensing data from the sensor node of the field network;
searching for, when a destination of the sensing data is a sensor node of another field network, a routing table in which path information corresponding to an extension destination address is stored using an input interface and a destination address of the first sensing data; and
transmitting the sensing data with reference to a next address and an output interface of a record corresponding to the destination address and the input interface of the first sensing data.

2. The method of claim 1, wherein the searching for of a routing table comprises converting, when the destination address of the sensing data is a short type, a short destination address to an extension type.

3. The method of claim 2, wherein the converting of the short destination address comprises converting the short destination address to the extension type using a personal access network (PAN) identifier of a field network that receives the first sensing data, dummy data, and the short destination address.

4. The method of claim 2, wherein the short type is formed in 2 bytes, and the extension type is formed in 6 bytes.

5. The method of claim 1, wherein the path information comprises an IP address and a network interface of a next router in which the first sensing data are to pass through.

6. The method of claim 5, further comprising:
receiving second sensing data to be transmit to a sensor node of a field network that is connected to the router as a destination from a router of another field network; and
transmitting the second sensing data to the sensor node with reference to a next address and an output interface of a record corresponding to an input interface and a destination address of the second sensing data.

7. The method of claim 6, wherein the transmitting of the second sensing data comprises converting, when the destination address of the sensing data is converted to an extension type, the destination address of the sensing data to an original destination address.

8. The method of claim 6, wherein the receiving of the second sensing data comprises receiving the second sensing data through a user datagram protocol (UDP) packet.

9. The method of claim 1, wherein the transmitting of the sensing data further comprises converting the sensing data to an UDP packet.

10. A method of routing a router in a relay network between a field network comprising at least one sensor node and a plant network comprising a management system, the method comprising:
receiving sensing data in which a destination is displayed as null from the sensor node of the field network;
searching for a routing table in which path information corresponding to an extension destination address is stored using an input interface and a destination address of the sensing data; and
transmitting the sensing data to the management system with reference to a next address and an output interface of a record corresponding to an input interface and the null of the sensing data.

11. The method of claim 10, wherein in the routing table, a next address in which the extension destination address corresponds to null comprises an address of a gateway of the relay network.

12. The method of claim 10, wherein the sensor node of the field network has a short medium access control (MAC) address of 2 bytes or an extension MAC address of 6 bytes.

13. A router of a relay network that relays data between a field network comprising at least one sensor node and a plant network comprising a management system, the router comprising:
a routing table that stores a next address and an output interface corresponding to an extension destination address and an input interface; and
a routing controller that converts, when a destination address of sensing data that receive from a sensor node of the field network is a short MAC address, the short MAC address to an extension MAC address and that transmits the sensing data through a next address and an output interface of a record corresponding to the extension MAC address and an input interface of sensing data with reference to the routing table.

14. The router of claim 13, wherein the router has an access point interface and an MAC address for an interface of a connecting field network and a network interface and an IP address for Internet protocol (IP) packet communication, and
the routing table is formed based on the access point interface, the MAC address, the network interface, and the IP address.

15. The router of claim 13, wherein the short MAC address is formed in 2 bytes, and the extension MAC address is formed in 6 bytes.

16. The router of claim 15, wherein the routing controller converts the short MAC address to the extension MAC address using a PAN identifier of the field network, dummy data, and the short MAC address.

17. The router of claim 16, wherein the routing controller converts the sensing data to an UDP packet and transmits the UDP packet.

18. The router of claim 13, wherein the next address and the output interface comprise an IP address and a network interface of a next router in which the sensing data are to pass through.

19. The router of claim 13, wherein the routing controller receives sensing data to be transmit to a sensor node of a sensor network that is connected to the router as a destination from a router of another field network and transmits the sensing data to the sensor node corresponding to the destination.

20. The router of claim 19, wherein the routing controller converts, when a destination address of the sensing data that receive from the router of the another field network is converted to an extension type, the destination address to a short destination address and transmits the sensing data to the sensor node.
